(19) United States
(12) Patent Application Publication
(10) Pub. No.: US 2023/0385235 A1
(43) Pub. Date: Nov. 30, 2023

(54) FILE MANAGEMENT SYSTEM, FILE MANAGEMENT METHOD, AND RECORDING MEDIUM WITH FILE MANAGEMENT PROGRAM RECORDED THEREON

(71) Applicant: SHARP KABUSHIKI KAISHA, Sakai City (JP)

(72) Inventor: YUUSUKE NAKATANI, Sakai City (JP)

(21) Appl. No.: 18/202,906

(22) Filed: May 27, 2023

(30) Foreign Application Priority Data
May 30, 2022 (JP) 2022-087528

(51) Int. Cl. G06F 16/11; G06F 16/17

(52) U.S. Cl. CPC G06F 16/122; G06F 16/173

(57) ABSTRACT

A file management system includes: a reception processing unit receiving, from a user, a selection operation to select a first file among files stored in a storage storing the files in association with security information set for the files; a display processing unit displaying, in a selectable manner, a candidate allowed to access the first file on the basis of the security information set for the first file; and a setting processing unit setting the candidate selected by the user, as a using person of the first file.

### INCORPORATION BY REFERENCE

This application is based upon and claims the benefit of priority from the corresponding Japanese Patent Application No. 2022-087528 filed on May 30, 2022, the entire contents of which are incorporated herein by reference.

### BACKGROUND

The present disclosure relates to a file management system, a file management method, and a recording medium with a file management program recorded thereon.

Systems that manage shared files stored on servers have been conventionally known. For example, a system that analyzes the contents or attributes of a document on a file stored in a server, sets an access right to the file, and, upon receiving an access request to the file from a user, provides the file to the user according to the access right has been known.

When a creator of a file shares the file with another user (sharer), the creator selects an address (e-mail address) of the shearer and transmits an e-mail with access information (URL) to the file, for example. When the sharer receives the e-mail, the sharer can browse or download the file based on the access information. Conventionally, when files are shared in such a manner, there has been a problem of information leakage, because a creator of a file can freely select a sharer, resulting in sharing the file with a third person who should not share the file.

### SUMMARY

An object of the present disclosure is to provide a file management system, a file management method, and a recording medium with a file management program recorded thereon, which are capable of preventing file information leakage.

A file management system according to one aspect of the present disclosure includes a reception processing unit, a display processing unit, and a setting processing unit. The reception processing unit receives, from a user, a selection operation to select a first file among files stored in a storage that stores the files in association with security information set for the files. The display processing unit displays, in a selectable manner, a candidate allowed to access the first file on the basis of the security information set for the first file. The setting processing unit sets the candidate selected by the user, as a using person of the first file.

A file management method according to another aspect of the present disclosure is executed by one or more processors, the method including receiving, from a user, a selection operation to select a first file among files stored in a storage that stores the files in association with security information set for the files, displaying, in a selectable manner, a candidate allowed to access the first file on the basis of the security information set for the first file, and setting the candidate selected by the user, as a using person of the first file.

A recording medium according to another aspect of the present disclosure is a recording medium with a file management program recorded thereon, the file management program causing one or more processors to receive, from a user, a selection operation to select a first file among files stored in a storage that stores the files in association with security information set for the files, display, in a selectable manner, a candidate allowed to access the first file on the basis of the security information set for the first file, and set the candidate selected by the user, as a using person of the first file.

According to the present disclosure, a file management system, a file management method, and a recording medium with a file management program recorded thereon which are capable of preventing file information leakage can be provided.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a functional block diagram illustrating a configuration of a file management system according to an embodiment of the present disclosure.

FIG. 2 is a diagram illustrating an example of an upload page displayed on a user terminal according to the embodiment of the present disclosure.

FIG. 3 is a diagram illustrating an example of the upload page displayed on the user terminal according to the embodiment of the present disclosure.

FIG. 4 is a diagram illustrating an example of file information used in the file management system according to the embodiment of the present disclosure.

FIG. 5 is a diagram illustrating an example of sharing setting information used in the file management system according to the embodiment of the present disclosure.

FIG. 6 is a diagram illustrating an example of user information used in the file management system according to the embodiment of the present disclosure.

FIG. 7 is a diagram illustrating an example of a file list page displayed on the user terminal according to the embodiment of the present disclosure.

FIG. 8 is a diagram illustrating an example of the file list page displayed on the user terminal according to the embodiment of the present disclosure.

FIG. 9 is a diagram illustrating an example of a transmission page displayed on the user terminal according to the embodiment of the present disclosure.

FIG. 10 is a diagram illustrating an example of the transmission page displayed on the user terminal according to the embodiment of the present disclosure.

FIG. 11 is a diagram illustrating an example of the transmission page displayed on the user terminal according to the embodiment of the present disclosure.

FIG. 12 is a flowchart for illustrating an example of a procedure of file management processing executed by the file management system according to the embodiment of the present disclosure.

### DETAILED DESCRIPTION

Hereinafter, an embodiment of the present disclosure will be described with reference to the accompanying drawings. Note that the following embodiment is merely an example that embodies the present disclosure, and is not intended to limit the technical scope of the present disclosure.

File Management System 10

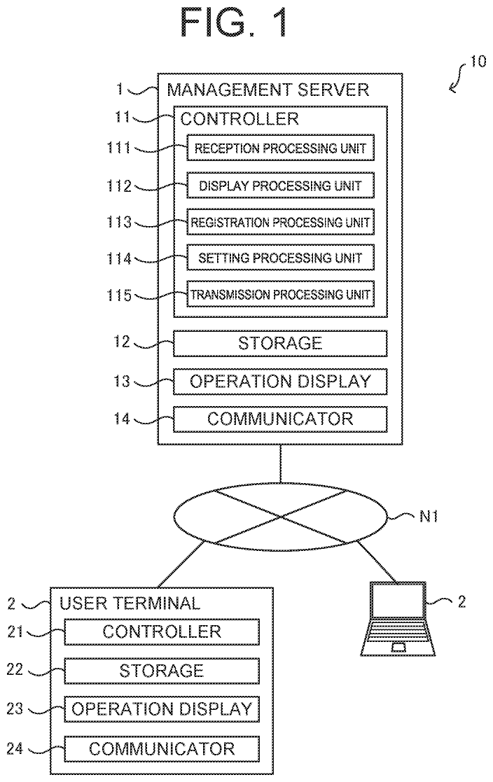

FIG. 1 is a block diagram illustrating a configuration of a file management system 10 according to an embodiment of the present disclosure. The file management system 10 includes a management server 1 and a user terminal 2. The management server 1 and the user terminal 2 are connected to each other via a network N1 (for example, the Internet, a LAN, etc.). The file management system 10 may include a plurality of user terminals 2.

In the file management system 10, the management server 1 manages a file uploaded from the user terminal 2. In addition, the management server 1 provides, to a user, a file management service managing a file stored in a storage 12. For example, the management server 1 manages a plurality of files stored in the storage 12 such that a plurality of user terminals 2 each can access the files via the network N1. That is, the management server 1 can manage the file as a shared file.

Each user of the plurality of user terminals 2 uploads a file such as a document file created by the user with own user terminal 2 to the management server 1 using a predetermined application program (file management application program). In addition, each user can access the management server 1 using the file management application program to browse a file and download a file to the user terminal 2.

The file management system 10 is an example of the file management system of the present disclosure. Note that the file management system of the present disclosure may be composed of the management server 1 alone.

Management Server 1

As illustrated in FIG. 1, the management server 1 includes a controller 11, a storage 12, an operation display 13, a communicator 14, and the like. The management server 1 may be composed of a personal computer, a network attached storage (NAS), or the like.

The communicator 14 is a communication interface for connecting the management server 1 to the network N1 in a wired or wireless manner and executing data communication with the user terminal 2 via the network N1 in accordance with a predetermined communication protocol. The network N1 is composed of, for example, the Internet or a LAN.

The operation display 13 is a user interface including a display such as a liquid crystal display or an organic EL display that displays various pieces of information, and an operation acceptor such as a mouse, a keyboard, or a touch panel that receives an operation.

The storage 12 is a non-volatile storage such as a hard disk drive (HDD), a solid state drive (SSD), or a flash memory that stores various pieces of information. The storage 12 stores data including a file managed by the management server 1. The storage 12 may be composed of a data server such as a NAS and connected to the management server 1 via the network N1.

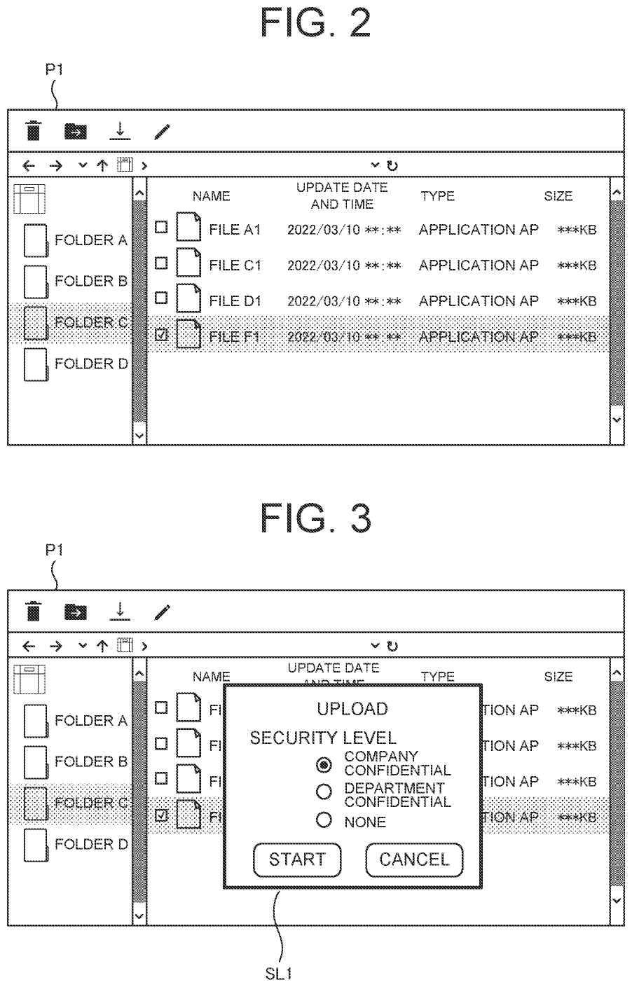

A user runs the file management application program on the user terminal 2 and uploads a desired file to the management server 1. As illustrated in FIG. 2 and FIG. 3, for example, the user selects a file on an upload page P1 displayed on the user terminal 2, sets a security level for the selected file, and uploads the file. Specifically, the user opens the upload page P1 in the file management application program on the user terminal 2. The upload page P1 displays a list of a plurality of files stored in the user terminal 2 in hierarchical structure by folder. FIG. 2 illustrates a state where the user selects file F1 stored in folder C. The user can select one or more files. After selecting file F1, the user selects a security level for file F1 selected on a security level setting screen SL1 (see FIG. 3). The security level includes a level (“company confidential”) at which share of (access to) the file is confined only within the company, a level (“department confidential”) at which share of (access to) the file is confined only within the department, and a level (“none”) at which share of (access to) the file is not limited. Note that the security level is not limited thereto and can be appropriately set according to use of the file management system 10. The user sets the security level for the file by selecting any of “company confidential,” “department confidential,” and “none.” The user selects the security level (for example, “company confidential”) and presses a “start” button. Consequently, file F1 for which the security level is set at “company confidential” is uploaded to the management server 1. Incidentally, identification information (user ID) pertaining to the creator of the file is imparted to file F1. The above-described security level is an example of security information of the present disclosure. The security level may be information corresponding to attribute information (affiliation or the like) pertaining to the creator of a file or may be information pertaining to the relationship between a file and a creator. That is, the security level may be information for defining the range of sharers of a file created by a creator.

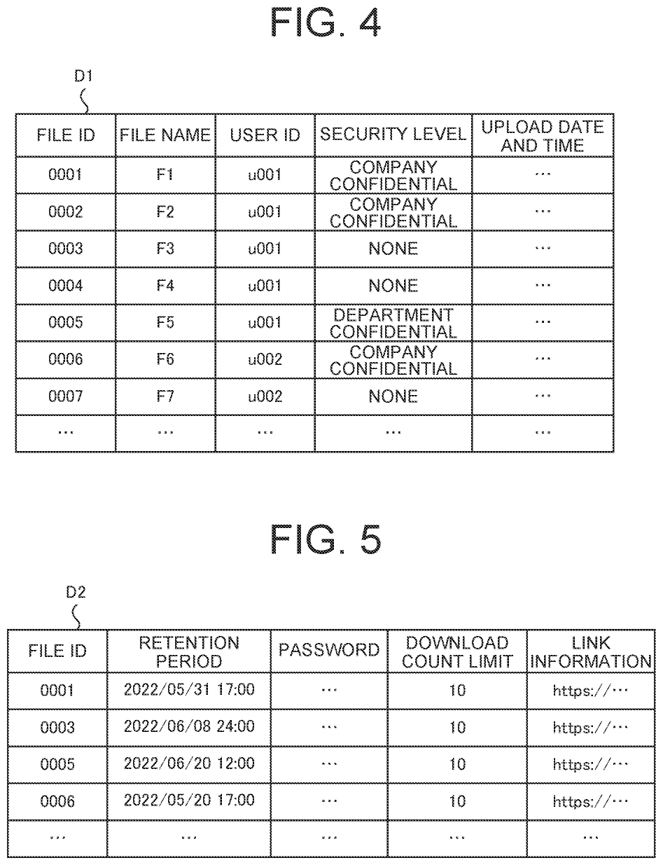

Each user can upload, to the management server 1, a desired file using own user terminal 2. The storage 12 stores a file uploaded from each user terminal 2. In addition, the storage 12 stores file information D1 pertaining to the file. FIG. 4 illustrates an example of the file information D1. The file information D1 includes pieces of information such as a “file ID,” a “file name,” a “user ID,” a “security level,” and an “upload date and time” for each file uploaded from the user terminal 2. The file ID is identification information on the file, the file name is a name set by a user for the file, and the user ID is identification information on the user (or the user terminal 2). The security level is a security level (“company confidential,” “department confidential,” “none,” etc.) set by the user. The upload date and time is the date and time when the file was uploaded from the user terminal 2 to the management server 1. The file information D1 includes attribute information (creation date, size, extension, update date, etc.) in addition to each piece of information.

In addition, the storage 12 stores sharing setting information D2 pertaining to a sharing setting for the file. FIG. 5 illustrates an example of the sharing setting information D2. As illustrated in FIG. 5, the sharing setting information D2 includes pieces of information such as a “file ID,” a “retention period,” a “password,” a “download count limit,” and “link information” for each file (shared file) with the sharing setting. The file ID is identification information on the shared file and corresponds to the file ID of the file information D1 (see FIG. 4). The retention period is a period during which the file can be retained as a shared file. For example, when the shared file is stored in another server (for example, a cloud server), the retention period is a period during which the file is retained in the cloud server. The password is a password set for the shared file. The download count limit is an upper limit on the number of times the shared file can be downloaded. The link information is access information for accessing the shared file and is a uniform resource locator (URL), for example. The controller 11 registers the retention period, the password, and the download count limit in the sharing setting information D2 on the basis of an input operation performed by the user. In addition, the controller 11 creates the link information and registers same in the sharing setting information D2 on the basis of a sharing setting operation performed by the user.

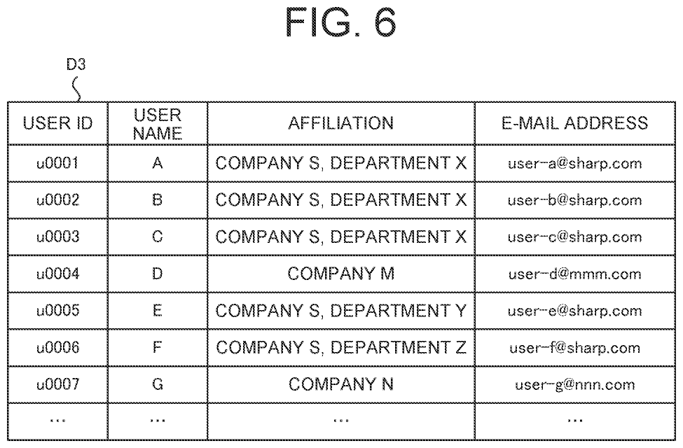

The storage 12 stores user information D3 pertaining to the user. FIG. 6 illustrates an example of the user information D3. As illustrated in FIG. 6, the user information D3 includes pieces of information such as a “user ID,” a “user name,” an “affiliation,” and an “e-mail address” for each user. Information pertaining to a user who can use the file management application program is registered in the user information D3, for example. The user ID is is identification information on the user and is used as login information for the file management application program, for example. The affiliation is information pertaining to an organization or a group to which the user belongs and is information of, for example, a company name, a department, and the like. The e-mail address is an e-mail address that the user terminal 2 can receive and is assigned to each user. The user information D3 is an example of an address book of the present disclosure. The address book may be created for each user.

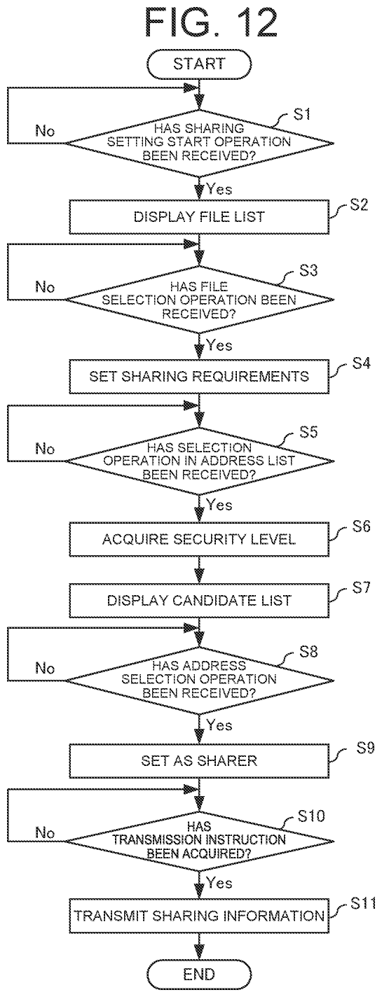

Furthermore, the storage 12 stores a file management program for causing the controller 11 to execute file management processing (see FIG. 12) described later. For example, the file management program is recorded in a computer-readable recording medium such as a CD or a DVD in a non-transitory manner, is read by a reader (not shown) such as a CD drive or a DVD drive included in the management server 1, and is stored in the storage 12. The file management program may be distributed from another server and stored in the storage 12.

The controller 11 includes a control device such as a CPU, a ROM, and a RAM. The CPU is a processor that executes various types of arithmetic processing. The ROM stores in advance a control program such as a BIOS or an OS for causing the CPU to execute various types of processing. The RAM stores various pieces of information and is used as a temporary storage memory (work area) for the various types of processing executed by the CPU. The controller 11 controls the management server 1 by causing the CPU to execute various control programs stored in advance in the ROM or the storage 12.

Specifically, as illustrated in FIG. 1, the controller 11 includes various processing units such as a reception processing unit 111, a display processing unit 112, a registration processing unit 113, setting processing unit 114, and transmission processing unit 115. The controller 11 functions as the various processing units by executing the various types of processing according to the file management program. Furthermore, some or all of processing units included in the controller 11 may be composed of an electronic circuit. The file management program may be a program for causing a plurality of processors to function as the various processing units.

The reception processing unit 111 receives various operations from each user terminal 2. Specifically, the reception processing unit 111 receives a file upload operation on an upload page P1 (see FIG. 2 and FIG. 3) displayed on the user terminal 2 by the display processing unit 112.

For example, the display processing unit 112 displays the upload page P1 on the user terminal 2 and displays, on the upload page P1, a list of a plurality of files stored in the user terminal 2. When the user selects a desired file on the upload page P1 (see FIG. 2), the reception processing unit 111 receives the selection operation, and the display processing unit 112 displays the security level setting screen SL1 (see FIG. 3). The display processing unit 112 displays, on the security level setting screen SL1, security levels (“company confidential,” “department confidential,” and “none”) in a selectable manner. For example, user A selects file F1 on the user terminal 2 (see FIG. 2) and selects “company confidential” as the security level for file F1 (see FIG. 3). When user A selects “company confidential” and presses the start button, the reception processing unit 111 receives the upload operation. The user terminal 2 executes processing to upload file F1.

When the upload processing is executed, the registration processing unit 113 acquires file F1 from the user terminal 2 and stores same in the storage 12. The registration processing unit 113 registers various pieces of information pertaining to file F1 in the file information D1 (see FIG. 4). For example, the registration processing unit 113 registers the file ID, the file name, the user ID (in this case, user ID “u001” of user A), the security level (“company confidential”), the upload date and time, the attribute information (creation date, size, extension, update date, etc.), and the like of file F1 in the file information D1. That is, the registration processing unit 113 registers the security level selected by the creator of a file in association with the file.

The controller 11 acquires a file and registers information pertaining to the file in the file information D1 on the basis of the upload operation performed by each of a plurality of users, in this manner.

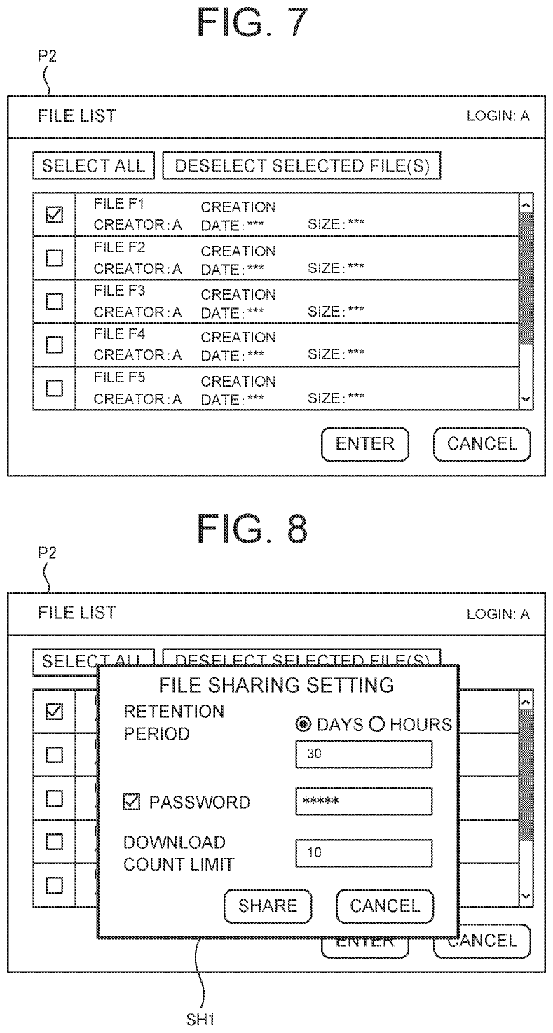

The user configures sharing setting for a desired file registered in the file information D1 when allowing access (browsing, download, etc.) by another user to the file. For example, when user A logs into the file management application program to configure the sharing setting, as illustrated in FIG. 7, the display processing unit 112 extracts file information corresponding to user A (user ID: “u001”) from the file information D1 and displays a file list page P2.

The reception processing unit 111 receives a selection operation to select a file (an example of the first file of the present disclosure) to be shared among files stored in the storage 12 by the creator of the files, from the creator. In the example illustrated in FIG. 7, the reception processing unit 111 receives the selection operation to select a file to be shared from user A. For example, user A selects file F1 and presses an enter button. When the reception processing unit 111 receives the selection operation, the display processing unit 112 displays a sharing setting screen SH1 (see FIG. 8). The sharing setting screen SH1 includes setting fields for the period (retention period) during which the file can be retained as a shared file, the password set for the shared file, and the upper limit (download count limit) on the number of times the shared file can be downloaded. User A inputs the retention period, the password, and the download count limit for file F1 and presses a share button.

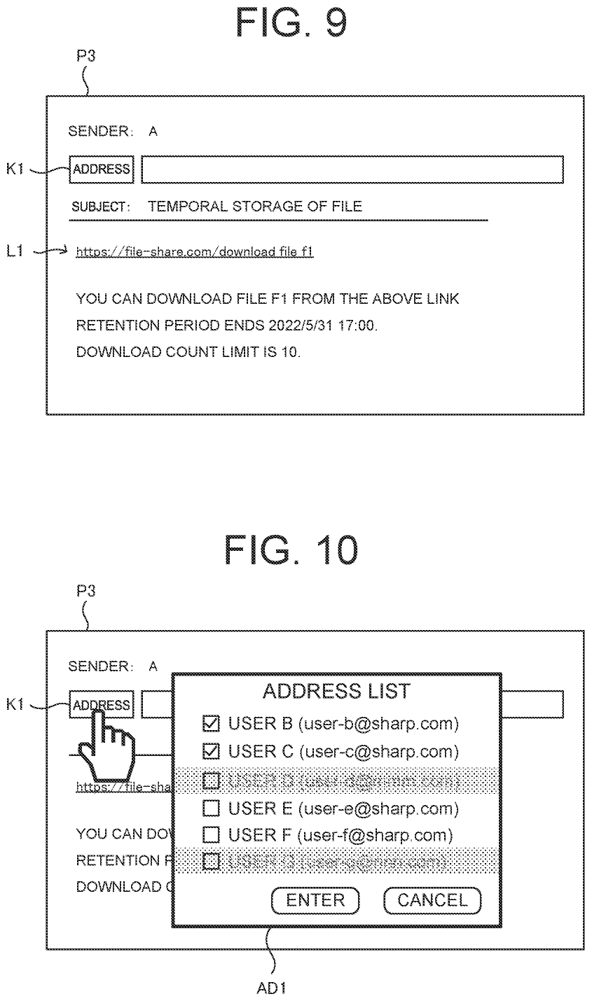

When user A presses the share button, as illustrated in FIG. 9, the display processing unit 112 creates access information (link information L1) to file F1 and displays, on the user terminal 2, a transmission page P3 to send an e-mail including the link information L1. The transmission page P3 includes an address field K1 to select an e-mail address and information such as the link information L1 (see FIG. 5) to access to file F1, the retention period for file F1, and the download count limit for file F1. When user A presses the address field K1, the display processing unit 112 displays, in a selectable manner, candidates who can access file F1 on the basis of the security level set for file F1 in an address list AD1 (see FIG. 10). For example, since “company confidential” is set, as the security level, for file F1 selected by user A (see FIG. 4), the display processing unit 112 displays users B, C, E, and F belonging to the same company as user A among the user information D3 (see FIG. 6) in a selectable state, and displays users D and G belonging to a company different from user A in an unselectable state, in the address list AD1 (see FIG. 10). The display processing unit 112 may display users D and G in a gray-out manner in the address list AD1 (see FIG. 10) or may not display users D and G.

In this manner, the display processing unit 112 displays, in a selectable manner, one or more registered users satisfying requirements according to the security level as the candidate among a plurality of registered users registered in the address book (user information D3) of the creator of the file. The display processing unit 112 displays, in an unselectable state, registered users not satisfying requirements according to the security level among a plurality of registered users registered in the address book of the creator.

The user selects one or more registered users from the plurality of registered users (candidates) displayed in the address list AD1 and presses the enter button. In this case, user A selects user B and user C and presses the enter button (see FIG. 10), for example.

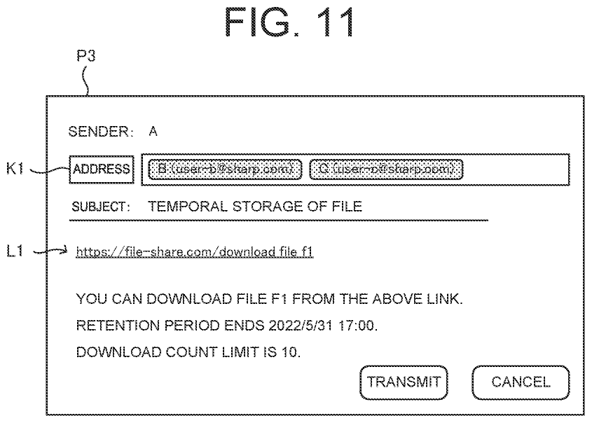

When user A presses the enter button, the setting processing unit 114 sets the candidates selected by user A as sharers (using persons) of file F1. When the sharers are set, the setting processing unit 114 sets e-mail addresses of the sharers in the address field K1 (see FIG. 11). In the example illustrated in FIG. 11, an e-mail address of user B and an e-mail address of user C are set in the address field K1.

When user A presses a transmission button on the transmission page P3 illustrated in FIG. 11, the transmission processing unit 115 transmits e-mails with sharing information including the link information L1 to the sharers set by the setting processing unit 114.

A user of the user terminal 2 receiving the e-mail selects (clicks) the link information L1. When the link information L1 is selected, the display processing unit 112 displays the file associated with the link information L1 on the user terminal 2. In addition, when the requirements of the retention period, the password, and the download count limit set for the file in the sharing setting information D2 (see FIG. 5) are satisfied, the display processing unit 112 expands the file on the user terminal 2 and allows the user to share the file through, for example, browsing or downloading the file. When the retention period has expired, the passed is wrong, or the download count exceeds the upper limit, the display processing unit 112 denies file sharing and notifies the user of an error, for example.

As described above, the management server 1 limits users who can share the file on the basis of the security information set for the file uploaded from the user terminal 2.

User Terminal 2

As illustrated in FIG. 1, the user terminal 2 includes a controller 21, a storage 22, an operation display 23, a communicator 24, and the like. The user terminal 2 is an information processing device such as a personal computer, a smartphone, or a tablet terminal.

The communicator 24 is a communication interface for connecting the user terminal 2 to the network N1 in a wired or wireless manner and for executing data communication between the user terminal 2 and an external device such as the management server 1 via the network N1 in accordance with a predetermined communication protocol.

The operation display 23 is a user interface that includes: a display, such as a liquid crystal display or an organic EL display, that displays information such as various web-pages; and an operation acceptor, such as a mouse, keyboard, or a touch panel, that accepts an operation.

The storage 22 is a non-volatile storage, such as a HDD, an SSD, or a flash memory, that stores various pieces of information. For example, the storage 22 stores a control program such as a browser program. Specifically, the browser program is a control program for causing the controller 21 to execute communication processing with an external device such as the management server 1 in accordance with a communication protocol such as Hypertext Transfer Protocol (HTTP). The browser program may be a dedicated application program for executing communication processing with the management server 1 in accordance with a predetermined communication protocol.

The controller 21 has control devices such as a CPU, a ROM, and a RAM. The CPU is a processor that executes various types of arithmetic processing. The ROM is a non-volatile storage that stores, in advance, control programs such as a BIOS and an OS for causing the CPU to execute various types of processing. The RAM is a volatile or non-volatile storage that stores various pieces of information, and is used as a temporary storage memory (work area) for various types of processing to be executed by the CPU. The controller 21 controls the user terminal 2 by causing the CPU to execute various control programs stored in advance in the ROM or the storage 22.

Specifically, the controller 21 functions as a browser processing unit by executing various types of processing in accordance with the browser program stored in the storage 22. The controller 21 can display, on the operation display 23, a web-page provided from the management server 1 via the network N1, and execute browser processing to input an operation on the operation display 23 into the management server 1. That is, the user terminal 2 can function as an operation terminal for the management server 1 when the browser program is executed by the controller 21. Some or all of the processing units included in the controller 21 may be composed of an electronic circuit.

When a user operation is performed to request access to a predetermined URL corresponding to the website of the file management service provided by the management server 1, the controller 21 in the user terminal 2 acquires data on the web-page of the website from the management server 1 and displays the web-page of the website on the operation display 23. When a predetermined application program (file management application program) corresponding to the management server 1 is installed on the user terminal 2, the web-page of the website is displayed on the operation display 23 through an operation performed by the user of the user terminal 2 to run the file management application program.

The controller 21 uploads a file stored in the user terminal 2 to the management server 1 in accordance with an operation performed by the user. The controller 21 allows the user to browse a file stored in the management server 1 or download the file to the user terminal 2 in accordance with an operation performed by the user.

The controller 21 causes the operation display 23 of the user terminal 2 to display a web-page such as the upload page P1 (see FIG. 2 and FIG. 3), the file list page P2 (see FIG. 7 and FIG. 8), or the transmission page P3 (see FIG. 9 to FIG. 11). The controller 21 receives an operation performed by the user on each web-page.

File Management Processing

Hereinafter, an example of a procedure of the file management processing executed by the file management system 10 will be described with reference to FIG. 12.

Note that the present disclosure can be considered as a disclosure of a file management method of executing one or more steps included in the file management processing. The one or more steps included in the file management processing described herein may be omitted as appropriate. The order of execution of the respective steps of the file management processing may vary as long as similar effects are provided. A case in which the controller 11 of the management server 1 executes each step in the file management processing will be described here as an example, but in other embodiments, one or more processors may execute each step in the file management processing in a dispersed manner. Here, as described in the above example, the management server 1 is assumed to store multiple files that multiple user terminals 2 each can access via the network N1 (see FIG. 4). The file management processing is executed in parallel in response to access from each of the multiple user terminals 2.

First, in step S1, the controller 11 determines whether a sharing setting start operation for a file has been received from a user terminal 2. Upon receiving the sharing setting start operation from the user terminal 2 (S1: Yes), the controller 11 shifts the processing to step S2. The controller 11 waits until the sharing setting start operation is received from a user terminal 2 (S1: No).

In step S2, the controller 11 displays the file list page P2 (see FIG. 7) on which files to be shared are listed. For example, when user A logs in, the controller 11 specifies the file ID associated with the user ID of user A in the file information D1 (see FIG. 4) and displays information on a file corresponding to the file ID on the file list page P2.

Next, in step S3, the controller 11 determines whether a file selection operation has been received from the user terminal 2. Upon receiving the file selection operation from the user terminal 2 (S3: Yes), the controller 11 shifts the processing to step S4. The controller 11 waits until the file selection operation is received from the user terminal 2 (S3: No). For example, user A selects file F1 on the file list page P2 displayed on the user terminal 2 (see FIG. 7).

In step S4, the controller 11 sets sharing requirements. Specifically, the controller 11 causes the user terminal 2 to display the sharing setting screen SH1 (see FIG. 8) and receives, from user A, a setting operation for setting the retention period, the password, and the download count limit. The controller 11 sets the sharing requirements (the retention period, the password, and the download count limit) for selected file F1 in accordance with the setting operation performed by user A.

Next, in step S5, the controller 11 determines whether an address field K1 selection operation has been received from the user terminal 2. Upon receiving the address field K1 selection operation from the user terminal 2 (S5: Yes), the controller 11 shifts the processing to step S6. The controller 11 waits until the address field K1 selection operation is received from the user terminal 2 (S5: No). For example, user A selects the address field K1 on the transmission page P3 (see FIG. 9) displayed on the user terminal 2.

In step S6, the controller 11 acquires the security level associated with the selected file. Specifically, the controller 11 acquires the security level (in this case, “company confidential”) associated with file F1 with reference to the file information D1 (see FIG. 4).

Next, in step S7, the controller 11 extracts candidates who can access the selected file and displays a list of the candidates. Specifically, the controller 11 extracts users B, C, E, and F belonging to the same company as user A with reference to the user information D3 (see FIG. 6), and displays a list of the users on the address list AD1 (see FIG. 10). The controller 11 may display users B, C, E, and F in a selectable state and display users D and G belonging to a company different from user A in an unselectable state, in the address list AD1 (see FIG. 10). The controller 11 extracts the candidates with reference to an address book (user information D3) associated with the user ID of user A.

Next, in step S8, the controller 11 determines whether an address (candidate) selection operation has been received from the user terminal 2. Upon receiving the address selection operation from the user terminal 2 (S8: Yes), the controller 11 shifts the processing to step S9. The controller 11 waits until the address selection operation is received from the user terminal 2 (S8: No). For example, user A selects user B and user C in the address list AD1 (see FIG. 10).

Next, in step S9, the controller 11 sets the selected users as sharers (using persons) of the file. In this case, the controller 11 sets user B and user C as sharers of file F1. The controller 11 sets the respective e-mail addresses of user B and user C set as the sharers in the address field K1 on the transmission page P3 (see FIG. 11).

Next, in step S10, the controller 11 determines whether an e-mail transmission instruction has been received from the user terminal 2. Upon receiving the e-mail transmission instruction from the user terminal 2 (S10: Yes), the controller 11 shifts the processing to step S11. The controller 11 waits until the e-mail transmission instruction is received from the user terminal 2 (S10: No). For example, when user A presses the transmission button on the transmission page P3 (see FIG. 11), the controller 11 receives the transmission instruction.

Next, in step S11, the controller 11 transmits an e-mail with sharing information including the link information L1 to the set sharers.

When each user of the user terminal 2 having received the e-mail selects (clicks) the link information L1, the controller 11 allows the user to share the file on the user terminal 2 through, for example, browsing or downloading the file if the retention period, the password, and the download count for the file satisfy the sharing requirements set in the sharing setting information D2.

As described above, the controller 11 executes the file management processing. The controller 11 executes the file management processing each time the sharing setting start operation is received from each user terminal 2.

As described above, the file management system 10 according to the present embodiment receives a selection operation to select a first file among files stored in the storage 12 that stores the file in association with the security information (security level) set by a creator of the file from the creator (an example of the user of the present disclosure), displays, in a selectable manner, a candidate allowed to access the first file on the basis of the security information set for the first file, and sets the candidate selected by the creator as a using person (sharer) of the first file.

According to the above configuration, the creator of the file can select, as the sharer, only the user corresponding to the security information. Consequently, only the user satisfying the requirements of the security information is allowed to access the file, and a user not satisfying the requirements of the security information is prevented from accessing the file. File information leakage can be prevented thereby.

The present disclosure is not limited to the above-described embodiment. The present disclosure may be the following embodiments.

As another embodiment of the present disclosure, the controller 11 may automatically set the security level on the basis of an attribute (contents, file name, etc. of the file) of the file independent of the setting operation (see FIG. 3) to set the security level performed by the creator of the file. For example, in a case where a document file contains a word such as “company confidential,” “department confidential,” “confidential matter,” or “important matter” in the document or in a case where a file name contains a word such as “departmental meeting record,” “company meeting record,” or “development theme,” the controller 11 may set the security level on the basis of such words. In addition, the controller 11 may mechanically learn an attribute of the file and estimate the security level.

As another embodiment of the present disclosure, the controller 11 may allow exceptional selection of a user not satisfying requirements according to the security level. For example, in the address list AD1 on the transmission page P3 illustrated in FIG. 10, when user A selects user D belonging to a company different from user A, the controller 11 displays, on the user terminal 2, a message (warning information) indicating that user D does not satisfy the security level (“company confidential”) to warn user A. In this case, when user A performs a confirmation operation in response to the message, the controller 11 may exceptionally set user D as a sharer (using person) of file F1.

In addition, the controller 11 may notify, for example, an administrator (superior or the like) of user A of an approval request corresponding to the message. The controller 11 may exceptionally set user D as a sharer (using person) of file F1 when the administrator of user A approves in response to the approval request.

As another embodiment of the present disclosure, the controller 11 may set a sharer (using person) of a file with reference to schedule information or calendar information. For example, when user A selects, as a file to be shared, a record of a meeting, the controller 11 may display, as candidates who can access the file, participants attending the meeting included in meeting information registered in schedule information or calendar information.

As another embodiment of the present disclosure, in a case where the management server 1 and the user terminal 2 cooperate to compose the file management system of the present disclosure, the user terminal 2 may execute e-mail creation processing. In this case, the controller 21 of the user terminal 2 may set a candidate (see FIG. 10) selected by a user as a sharer (using person) of a file and transmit an e-mail.

As another embodiment of the present disclosure, the reception processing unit 111 may receive a selection operation to select a file (an example of the first file of the present disclosure) to be shared among files stored in the storage 12 from a user different from the creator of the file. For example, the reception processing unit 111 may determine authority for the selection operation to select the file on the basis of information such as an attribute of a user or the security level set for the file and receive the file selection operation performed by the user when the user has the authority to perform the selection operation. That is, in the present disclosure, a user who creates a file and sets security information may be the same as or different from a user who selects the file stored in the storage 12.

### SUPPLEMENTARY NOTES OF DISCLOSURE

An outline of the disclosure derived from the above embodiments will be described below as supplementary notes. The respective configurations and the processing functions described in the following supplementary notes can be selected to be added or omitted and combined arbitrarily.

### Supplementary Note 1

A file management system includes: a reception processing unit receiving, from a user, a selection operation to select a first file among files stored in a storage storing the files in association with security information set for the files; a display processing unit displaying, in a selectable manner, a candidate allowed to access the first file on the basis of the security information set for the first file; and a setting processing unit setting the candidate selected by the user, as a using person of the first file.

### Supplementary Note 2

The file management system described in supplementary note 1 further includes a registration processing unit registering the files in the storage, in which the registration processing unit registers, among a plurality of security levels, a security level selected by the user in association with each of the files.

### Supplementary Note 3

In the file management system described in supplementary note 1 or 2, the setting processing unit sets the candidate selected by the user as a destination of an e-mail including access information to the first file.

### Supplementary Note 4

The file management system described in supplementary note 3 further includes a transmission processing unit transmitting the e-mail to the using person set by the setting processing unit.

### Supplementary Note 5

In the file management system described in supplementary note 3 or 4, the access information is link information for access to the first file.

### Supplementary Note 6

In the file management system described in any of supplementary notes 1 to 5, the display processing unit displays, in a selectable manner, one or more registered users satisfying requirements according to the security information as the candidate among a plurality of registered users registered in an address book of the user.

### Supplementary Note 7

In the file management system described in supplementary note 6, the display processing unit displays, in an unselectable state, a registered user not satisfying the requirements according to the security information among the plurality of registered users registered in the address book of the user.

### Supplementary Note 8

In the file management system described in any of supplementary notes 1 to 7, the security information is information corresponding to attribute information pertaining to the user.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

What is claimed is:

1. A file management system, comprising:
a reception processing circuit receiving, from a user, a selection operation to select a first file among files stored in a storage storing the files in association with security information set for the files;
a display processing circuit displaying, in a selectable manner, a candidate allowed to access the first file on the basis of the security information set for the first file; and
a setting processing circuit setting the candidate selected by the user, as a using person of the first file.

2. The file management system according to claim 1, further comprising a registration processing circuit registering the files in the storage, wherein
the registration processing circuit registers, among a plurality of security levels, a security level selected by the user in association with each of the files.

3. The file management system according to claim 1, wherein
the setting processing circuit sets the candidate selected by the user as a destination of an e-mail including access information to the first file.

4. The file management system according to claim 3, further comprising a transmission processing circuit transmitting the e-mail to the using person set by the setting processing circuit.

5. The file management system according to claim 3, wherein
the access information is link information for access to the first file.

6. The file management system according to claim 1, wherein
the display processing circuit displays, in a selectable manner, one or more registered users satisfying requirements according to the security information as the candidate among a plurality of registered users registered in an address book of the user.

7. The file management system according to claim 6, wherein
the display processing circuit displays, in an unselectable state, a registered user not satisfying the requirements according to the security information among the plurality of registered users registered in the address book of the user.

8. The file management system according to claim 1, wherein
the security information is information corresponding to attribute information pertaining to the user.

9. A file management method executed by one or more processors, the method comprising:
receiving, from a user, a selection operation to select a first file among files stored in a storage that stores the files in association with security information set for the files;
displaying, in a selectable manner, a candidate allowed to access the first file on the basis of the security information set for the first file; and
setting the candidate selected by the user, as a using person of the first file.

10. A non-transitory computer-readable recording medium with a file management program recorded thereon, the file management program causing one or more processors to
receive, from a user, a selection operation to select a first file among files stored in a storage that stores the files in association with security information set for the files,
display, in a selectable manner, a candidate allowed to access the first file on the basis of the security information set for the first file, and
set the candidate selected by the user, as a using person of the first file.
